(19) United States
(12) Patent Application Publication
(10) Pub. No.: US 2020/0043417 A1
(43) Pub. Date: Feb. 6, 2020

(54) PIXEL DRIVING CIRCUIT AND METHOD FOR DRIVING THE SAME, DISPLAY SUBSTRATE AND DISPLAY DEVICE

(71) Applicant: BOE TECHNOLOGY GROUP CO., LTD., Beijing (CN)

(72) Inventors: Shengji YANG, Beijing (CN); Xue DONG, Beijing (CN); Jing LV, Beijing (CN); Xiaochuan CHEN, Beijing (CN); Can ZHANG, Beijing (CN); Wei SUN, Beijing (CN); Lingyun SHI, Beijing (CN)

(73) Assignee: BOE TECHNOLOGY GROUP CO., LTD., Beijing (CN)

(21) Appl. No.: 15/738,853

(22) PCT Filed: Jun. 12, 2017
(86) PCT No.: PCT/CN2017/087881

§ 371 Date: Dec. 21, 2017

(30) Foreign Application Priority Data
Oct. 28, 2016 (CN) 201610975844.7

(51) Int. Cl. G09G 3/3266; G06K 9/00; G09G 3/3291

(52) U.S. Cl. CPC G09G 3/3266; G09G 2310/0278; G09G 3/3291; G06K 9/0002

(57) ABSTRACT

A pixel driving circuit and a method for driving the same, a display substrate and a display device are provided. The pixel driving circuit includes a display driving unit and a fingerprint identification unit. The display driving unit includes a driving transistor, a display storage sub-circuit, a data writing sub-circuit, a light-emitting control sub-circuit and a compensation control sub-circuit. The fingerprint identification unit includes a fingerprint detection sub-circuit and a conduction control sub-circuit. The fingerprint detection sub-circuit is configured to convert touch fingerprint information to a fingerprint current signal. The conduction control sub-circuit is configured to, during the light-emitting phase and in response to the second scanning signal, transmit the fingerprint current signal to the fingerprint current signal reading line.

### CROSS-REFERENCE TO RELATED APPLICATION

This application claims priority to Chinese Patent Application No. 201610975844.7 filed Oct. 28, 2016, the disclosures of which are incorporated in their entirety by reference herein.

### TECHNICAL FIELD

The present disclosure relates to the field of display driving technology, and in particularly to a pixel driving circuit and a method for driving the same, a display substrate and a display device.

### BACKGROUND

In the related art, it is unable to integrate a pixel compensation driving part and a fingerprint identification part of a pixel driving circuit. In the case that the pixel compensation driving and the fingerprint identification are achieved by multiplexing signal lines, the number of control lines may not be reduced. In addition, in the pixel driving circuit with a fingerprint identification function in the related art, it is common to divide a frame period into a display period and a fingerprint identification period, and then the display driving and the fingerprint identification are performed in a time sequence, however it is unable to provide a solution where an organic light-emitting diode (OLED) can be driven to emit light meanwhile the fingerprint identification is performed in a simple time sequence. In the pixel driving circuit in the related art, the pixel compensation driving and the fingerprint identification are performed in a time sequence, so it is required to spare a certain time period for the display driving to perform the fingerprint identification, while it is unable to utilize a whole frame period to perform the pixel driving compensation, therefore the time spend on the fingerprint identification is reduced and then it is unable to improve the fingerprint identification accuracy. In addition, since a frame period is divided to perform the display driving and the fingerprint identification respectively, it is unable to reduce a time length of a display period and improve a display rate.

### SUMMARY

An objective of the present disclosure is to provide a pixel driving circuit and a method for driving the same, a display substrate and a display device, so as to solve the technical issue in the related art to provide a solution where an organic light-emitting diode (OLED) can be driven to emit light meanwhile the fingerprint identification is performed in a simple time sequence.

To achieve the above objective, a pixel driving circuit is provided in the present disclosure, including a display driving unit and a fingerprint identification unit, where the display driving unit includes: a driving transistor, where a gate electrode of the driving transistor is coupled to a first node, a first electrode of the driving transistor is coupled to a second node, and a second electrode of the driving transistor is coupled to a light-emitting component; a display storage sub-circuit, where a first end of the display storage sub-circuit is coupled to a third node, and a second end of the display storage sub-circuit is coupled to the second node; a data writing sub-circuit, coupled to a first scanning line, the first node, the third node, a data line and an initial voltage output end; a light-emitting control sub-circuit, coupled to a light-emitting line, a high-level output end and the second node; and a compensation control sub-circuit, coupled to the first scanning line, a second scanning line, the first node, the third node, the second electrode of the driving transistor and a low-level output end, and configured to, during a compensation phase and in response to a first scanning signal from the first scanning line, enable the second electrode of the driving transistor to be coupled to the low-level output end, to enable the display storage sub-circuit to discharge to the low-level output end through the driving transistor until the driving transistor is turned off, and further configured to, during a light-emitting phase and in response to a second scanning signal from the second scanning line, enable the first node to be coupled to the third node, to turn on the driving transistor to drive the light-emitting component to emit light, and enable a gate-source voltage of the driving transistor to compensate a threshold voltage of the driving transistor; the fingerprint identification unit includes a fingerprint detection sub-circuit and a conduction control sub-circuit, where the fingerprint detection sub-circuit is configured to convert touch fingerprint information to a fingerprint current signal; and the conduction control sub-circuit is coupled to the second scanning line, a fingerprint current signal reading line and the fingerprint detection sub-circuit, and configured to, during the light-emitting phase and in response to the second scanning signal, enable the fingerprint detection sub-circuit to be coupled to the fingerprint current signal reading line, to transmit the fingerprint current signal to the fingerprint current signal reading line.

Optionally, the fingerprint detection sub-circuit includes a fingerprint detection electrode and a fingerprint information detection sub-circuit, the fingerprint detection electrode is configured to convert the touch fingerprint information to a fingerprint capacitance, and the fingerprint information detection sub-circuit is coupled to the fingerprint detection electrode and configured to convert the fingerprint capacitance to the fingerprint current signal.

Optionally, the fingerprint detection electrode is coupled to a fourth node; the fingerprint information detection sub-circuit includes: a reset sub-circuit, coupled to the first scanning line, a reset signal output end and the fourth node, and configured to, in response to the first scanning signal, determine whether to connect the fourth node to the reset signal output end; a reference capacitor, where a first end of the reference capacitor is coupled to the first scanning line or the second scanning line, and a second end of the reference capacitor is coupled to the fourth node; and a fingerprint information detection transistor, where a gate electrode of the fingerprint information detection transistor is coupled to the fourth node, a first electrode of the fingerprint information detection transistor is coupled to the conduction control sub-circuit, and a second electrode of the fingerprint information detection transistor is coupled to the reset signal output end.

Optionally, the reset sub-circuit includes a reset transistor, a gate electrode of the reset transistor is coupled to the first scanning line, a first electrode of the reset transistor is coupled to the fourth node, and a second electrode of the reset transistor is coupled to the reset signal output end; the conduction control sub-circuit includes a conduction control transistor, a gate electrode of the conduction control transistor is coupled to the second scanning line, a first electrode of the conduction control transistor is coupled to the fingerprint current signal reading line, and a second electrode of the conduction control transistor is coupled to the first electrode of the fingerprint information detection transistor.

Optionally, the data writing sub-circuit is configured to, in response to the first scanning signal from the first scanning line, determine whether to apply a data voltage on a data line to the first node and whether to apply an initial voltage output by the initial voltage output end to the third node; the light-emitting control sub-circuit is configured to, in response to a light-emitting control signal from the light-emitting control line, determine whether to connect the second node to the high-level output end.

Optionally, the compensation control sub-circuit includes: a first compensation control transistor, where a gate electrode of the first compensation control transistor is coupled to the second scanning line, a first electrode of the first compensation control transistor is coupled to the third node, and a second electrode of the first compensation control transistor is coupled to the first node; a second compensation control transistor, where a gate electrode of the second compensation control transistor is coupled to the first scanning line, a first electrode of the second compensation control transistor is coupled to the second electrode of the driving transistor, and a second electrode of the second compensation control transistor is coupled to the low-level output end.

Optionally, the display storage sub-circuit includes a storage capacitor, the data writing sub-circuit includes: a data voltage writing transistor, where a gate electrode of the data voltage writing transistor is coupled to the first scanning line, a first electrode of the data voltage writing transistor is coupled to the data line, and the second electrode of the data voltage writing transistor is coupled to the first node; and an initial voltage writing transistor, where a gate electrode of the initial voltage writing transistor is coupled to the first scanning line, a first electrode of the initial voltage writing transistor is coupled to the initial voltage output end, and the second electrode of the initial voltage writing transistor is coupled to the third node; the light-emitting control sub-circuit includes a light-emitting control transistor, where a gate electrode of the light-emitting control transistor is coupled to the light-emitting control line, a first electrode of the light-emitting control transistor is coupled to the high-level output end, and the second electrode of the light-emitting control transistor is coupled to the second node.

Optionally, the fingerprint information detection sub-circuit includes the reset sub-circuit, the reset sub-circuit includes a reset transistor, and the conduction control sub-circuit includes the conduction control transistor, and the driving transistor, the reset transistor, the conduction control transistor, the first compensation control transistor, the second compensation control transistor, the data voltage writing transistor, the initial voltage writing transistor and the light-emitting control transistor are P-type transistors; the first scanning signal from the first scanning line and the second scanning signal from the second scanning line have reverse phases.

Optionally, the first scanning line is identical to the second scanning line.

Optionally, the conduction control sub-circuit includes the conduction control transistor, the first compensation control transistor and the conduction control transistor are N-type transistors, and the initial voltage writing transistor, the data voltage writing transistor and the second compensation control transistor are P-type transistors; or the first compensation control transistor and the conduction control transistor are P-type transistors, and the initial voltage writing transistor, the data voltage writing transistor and the second compensation control transistor are N-type transistors.

A method for driving the above pixel driving circuit is further provided in the present disclosure, where during each display period, the method includes: a reset step, including: during a reset phase and in response to a first scanning signal from the first scanning line, the data writing sub-circuit enabling a data voltage on the data line to be applied to the first node and the enabling an initial voltage output by the initial voltage output end to be applied to the third node; and in response to a light-emitting control signal from the light-emitting control line, the light-emitting control sub-circuit enabling the second node to be coupled to the high-level output end; a compensation step, including: in response to the light-emitting control signal, the light-emitting control sub-circuit enabling the second node to be disconnected with the high-level output end; in response to the first scanning signal, the compensation control sub-circuit enabling the second electrode of the driving transistor to be coupled to the low-level output end, to enable the display storage sub-circuit to discharge to the low-level output end through the driving transistor until a potential of the second node reaches a difference value the data voltage and a threshold voltage of the driving transistor and the driving transistor is turned off; a light-emitting step, including: during a light-emitting phase and in response to the first scanning signal, the data writing sub-circuit enabling the data line to be disconnected with the first node and enabling the initial voltage output end to be disconnected with the third node; in response to the light-emitting control signal, the light-emitting control sub-circuit enabling the second node to be coupled to the high-level output end; in response to a second scanning signal from the second scanning line, the compensation control sub-circuit enabling the first node to be coupled to the third node, to turn on the driving transistor to drive the light-emitting component to emit light, and enable a gate-source voltage of the driving transistor to compensate the threshold voltage of the driving transistor; the fingerprint detection sub-circuit converting touch fingerprint information to a fingerprint current signal; in response to the second scanning signal, the conduction control sub-circuit enabling the fingerprint detection sub-circuit to transmit the fingerprint current signal to the fingerprint current signal reading line.

Optionally, in the case that the fingerprint detection sub-circuit includes a fingerprint detection electrode and a fingerprint information detection sub-circuit, the fingerprint detection sub-circuit converting touch fingerprint information to a fingerprint current signal includes: converting, by the fingerprint detection electrode, the touch fingerprint information to a fingerprint capacitance; and converting, by the fingerprint information detection sub-circuit, the fingerprint capacitance to the fingerprint current signal.

A display substrate is further provided in the present disclosure, including the above pixel driving circuit.

Optionally, the display substrate further includes a silicon substrate, where the pixel driving circuit is arranged on the silicon substrate.

Optionally, the display substrate further includes n×N rows and m×M columns of pixel units, where the display substrate includes N rows and M columns of pixel driving circuit; the pixel driving circuit in an a^{th} row and b^{th} column is arranged in the pixel unit in a (n×a)^{th} row and (m×b)^{th} column; where n, N, m and M are positive integers, a is a positive integer smaller than or equal to N, b is a positive integer smaller than or equal to M.

A display device is further provided in the present disclosure, including the above display substrate.

Compared with the related art, according to a pixel driving circuit and a method for driving the same, a display substrate and a display device in the present disclosure, the light-emitting line, the first scanning line, the second scanning line and the light-emitting control line are multiplexed for the pixel compensation driving and the fingerprint identification, thereby reducing the number of control lines and the integrating the pixel compensation driving function and the fingerprint identification function. Compared with the related art where a frame period is divided into a display period and a fingerprint identification period and then the display driving and the fingerprint identification are performed in a time sequence, according to the present disclosure, it is able to perform the pixel compensation driving and the fingerprint identification simultaneously, thereby it is not required to spare a certain time period for the display driving to perform the fingerprint identification, and it is able to utilize a whole frame period to perform the pixel driving compensation. In addition, the time spend on the fingerprint identification is increased, and the fingerprint identification accuracy is improved. Furthermore, because the display driving and the fingerprint identification are performed simultaneously, a time length of a display period may be reduced and a display rate may be improved.

### BRIEF DESCRIPTION OF THE DRAWINGS

FIG. 1 is a schematic view of a pixel driving circuit in some embodiments of the present disclosure;

FIG. 2 is a schematic view of a pixel driving circuit in some embodiments of the present disclosure;

FIG. 3A is a schematic view of a pixel driving circuit in some embodiments of the present disclosure;

FIG. 3B is a schematic view showing a coupling capacitance between a finger and a fingerprint detection electrode d of a fingerprint detection sub-circuit of the pixel driving circuit shown in FIG. 3A;

FIG. 4 is a circuit diagram of a pixel driving circuit in some embodiments of the present disclosure;

FIG. 5 is a working time sequence diagram of the pixel driving circuit shown in FIG. 4;

FIG. 6A is a schematic view showing a current flowing direction during a reset phase t1 of the pixel driving circuit shown in FIG. 4;

FIG. 6B is a schematic view showing a current flowing direction during a reset phase t2 of the pixel driving circuit shown in FIG. 4;

FIG. 6C is a schematic view showing a current flowing direction during a light-emitting phase t3 of the pixel driving circuit shown in FIG. 4;

FIG. 7A is a circuit diagram of a pixel driving circuit in some embodiments of the present disclosure;

FIG. 7B is a working time sequence diagram of the pixel driving circuit shown in FIG. 7A; and

FIG. 8 is a schematic view of a display substrate with a pixel driving circuit in some embodiments of the present disclosure.

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

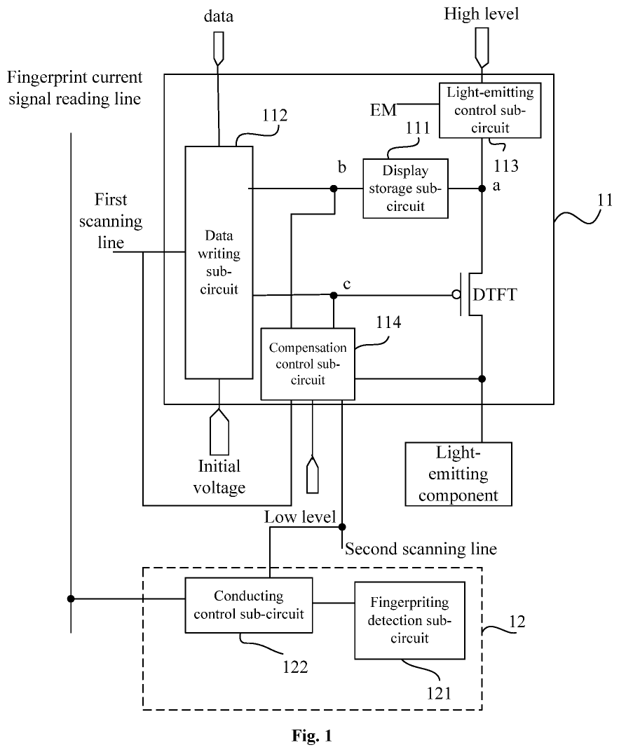

As shown in FIG. 1, a pixel driving circuit is provided in some embodiments of the present disclosure, including a display driving unit 11 and a fingerprint identification unit 12.

The display driving unit 11 includes: a driving transistor DTFT, where a gate electrode of the driving transistor DTFT is coupled to a first node c, a first electrode of the driving transistor is coupled to a second node a, and a second electrode of the driving transistor is coupled to a light-emitting component EL; a display storage sub-circuit 111, where a first end of the display storage sub-circuit is coupled to a third node b, and a second end of the display storage sub-circuit is coupled to the second node a; a data writing sub-circuit 112, coupled to a first scanning line Scan1, the first node c, the third node b, a data line Data and an initial voltage output end configured to output an initial voltage Vini; a light-emitting control sub-circuit 113, coupled to a light-emitting line EM, a high-level output end configured to output a high level Vdd and the second node a; and a compensation control sub-circuit 114, coupled to the first scanning line Scan1, a second scanning line Scan2, the first node c, the third node b, the second electrode of the driving transistor and a low-level output end configured to output a low level Vss, and configured to, during a compensation phase and in response to a first scanning signal from the first scanning line Scan1, enable the second electrode of the driving transistor DTFT to be coupled to the low-level output end configured to output a low level Vss, to enable the display storage sub-circuit 111 to discharge to the low-level output end through the driving transistor DTFT until the driving transistor DTFT is turned off, and further configured to, during a light-emitting phase and in response to a second scanning signal from the second scanning line Scan2, enable the first node c to be coupled to the third node b, to turn on the driving transistor DTFT to drive the light-emitting component EL to emit light, and enable a gate-source voltage of the driving transistor DTFT to compensate a threshold voltage of the driving transistor DTFT.

The fingerprint identification unit 12 includes a fingerprint detection sub-circuit 121 and a conduction control sub-circuit 122, where the fingerprint detection sub-circuit 121 is configured to convert touch fingerprint information to a fingerprint current signal.

The conduction control sub-circuit 122 is coupled to the second scanning line Scan2, a fingerprint current signal reading line Y-Read Line and the fingerprint detection sub-circuit 121, and configured to, during the light-emitting phase and in response to the second scanning signal, enable the fingerprint detection sub-circuit 121 to be coupled to the fingerprint current signal reading line Y-Read Line, to output the fingerprint current signal detected by the fingerprint detection sub-circuit 121 via the fingerprint current signal reading line Y-Read Line.

According to the pixel driving circuit in some embodiments of the present disclosure, a display substrate and a display device in the present disclosure, the light-emitting line, the first scanning line Scan 1, the second scanning line Scan 2 and the light-emitting control line EM are multiplexed for the pixel compensation driving and the fingerprint identification, thereby reducing the number of control lines and the integrating the pixel compensation driving function and the fingerprint identification function. Compared with the related art where a frame period is divided into a display period and a fingerprint identification period and then the display driving and the fingerprint identification are performed in a time sequence, according to the present disclosure, it is able to perform the pixel compensation driving and the fingerprint identification simultaneously, thereby it is not required to spare a certain time period for the display driving to perform the fingerprint identification, and it is able to utilize a whole frame period to perform the pixel driving compensation. In addition, the time spend on the fingerprint identification is increased, and the fingerprint identification accuracy is improved. Furthermore, because the display driving and the fingerprint identification are performed simultaneously, a time length of a display period may be reduced and a display rate may be improved.

As shown in FIG. 1, the DTFT is a P-type transistor. However, in an actual use, the DTFT may also be a N-type transistor, and the type of the DTFT is not limited herein.

In some embodiments of the present disclosure, as shown in FIG. 1, the Scan2 is a fingerprint identification scanning line, and the Y-Read Line is a fingerprint identification sensing line.

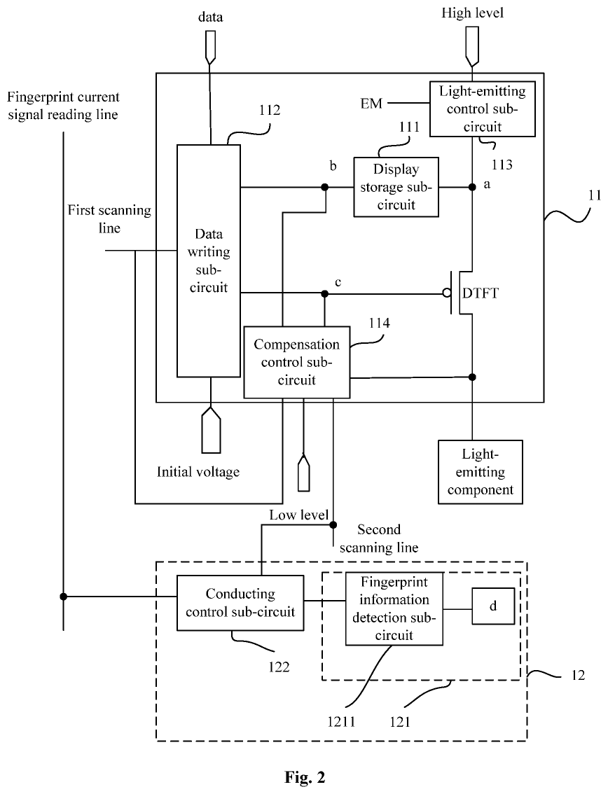

To be specific, as shown in FIG. 2, the fingerprint detection sub-circuit 121 includes a fingerprint detection electrode d and a fingerprint information detection sub-circuit 1211.

The fingerprint detection electrode d is configured to convert the touch fingerprint information to a fingerprint capacitance.

The fingerprint information detection sub-circuit 1211 is coupled to the fingerprint detection electrode d and configured to convert the fingerprint capacitance to the fingerprint current signal.

When the fingerprint detection sub-circuit 121 works, a finger touches the screen, a terminal acquires, based on a coupling capacitance between concave-convex stripes on the finger surface and the detection electrode, a terminal may acquire signals to determine the concave-convex stripes information of the finger surface, so as to acquire the fingerprint data.

In an actual use, the fingerprint electrode may be a detection electrode of a silicon sensor. The fingerprint electrode serves as one electrode plate of a capacitor, and the finger serves as the other electrode plate of the capacitor, so as to determine a potential of a gate electrode of a thin film transistor (TFT) of a fingerprint information detection sub-circuit based on a capacitance difference between concave-convex stripes of the fingerprint and the detection electrode of the silicon sensor and based on the coupling capacitance difference value, where the gate electrode of the TFT is coupled to the fingerprint detection electrode. The TFT then converts the potential of the gate electrode to a fingerprint current signal, and the terminal acquires a fingerprint grayscale image by an analog computation.

In an actual use, the fingerprint detection electrode may also be other types of conducting electrode, when being touched with concave-convex portions of the finger, it is able to generated different coupling capacitance there between, so the type of the fingerprint detection electrode is not limited herein.

To be specific, the fingerprint detection electrode is coupled to a fourth node.

The fingerprint information detection sub-circuit includes: a reset sub-circuit, coupled to the first scanning line, a reset signal output end and the fourth node, and configured to, in response to the first scanning signal, determine whether to connect the fourth node to the reset signal output end; a reference capacitor, where a first end of the reference capacitor is coupled to the first scanning line or the second scanning line, and a second end of the reference capacitor is coupled to the fourth node; and a fingerprint information detection transistor, where a gate electrode of the fingerprint information detection transistor is coupled to the fourth node, a first electrode of the fingerprint information detection transistor is coupled to the conduction control sub-circuit, and a second electrode of the fingerprint information detection transistor is coupled to the reset signal output end.

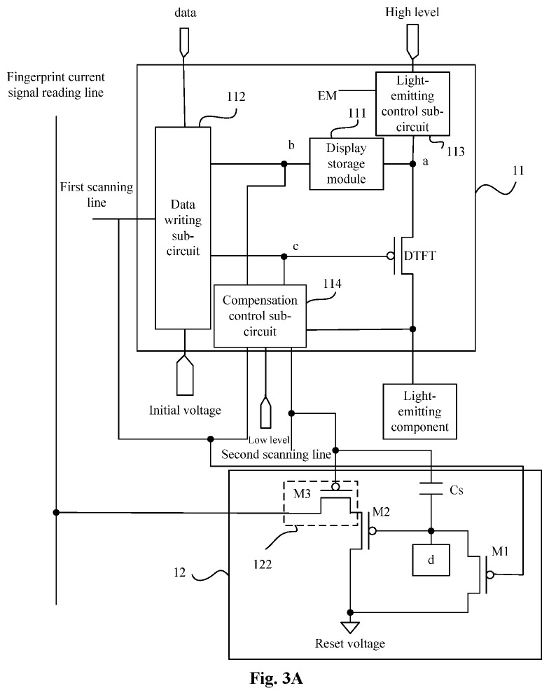

In some embodiments of the present disclosure, as shown in FIG. 3A, the conduction control sub-circuit 122 includes a conduction control transistor M3, a gate electrode of the conduction control transistor M3 is coupled to the second scanning line Scan2, a first electrode of the conduction control transistor M3 is coupled to the fingerprint current signal reading line Y-Read Line.

The fingerprint information detection sub-circuit includes: a reset transistor M1, where a gate electrode of the reset transistor M1 is coupled to the first scanning line Scan1, a first electrode of the reset transistor M1 is coupled to the reset signal output end configured to output a reset voltage Vcom, and a second electrode of the reset transistor M1 is coupled to the fingerprint detection electrode d; and a reference capacitor Cs, where a first end of the reference capacitor Cs is coupled to the first scanning line Scan1, and a second end of the reference capacitor Cs is coupled to the fourth node; and a fingerprint information detection transistor M2, where a gate electrode of the fingerprint information detection transistor M2 is coupled to the fingerprint detection electrode d, a first electrode of the fingerprint information detection transistor M2 is coupled to the second electrode of conduction control sub-circuit, and a second electrode of the fingerprint information detection transistor M2 is coupled to the reset signal output end.

In some embodiments of the present disclosure, as shown in FIG. 3A, the transistors M1, M2 and M3 are P-type TFTs, where the first electrode of each transistor may be a source electrode, and the second electrode thereof may be a drain electrode. In an actual use, the transistors M1, M2 and M3 may be N-type transistors, and the type of the transistor is not limited herein. In the case that the transistor M2 is an amplification transistor, when the transistor M2 is turned on, the current amplification times of the M2 is relative large.

As shown in FIG. 3B, when the fingerprint detection sub-circuit of the pixel driving circuit shown in FIG. 3A works, the fingerprint detection sub-circuit includes a coupling capacitance Cf between the finger and the fingerprint detection electrode d besides the reference capacitor Cs. Meanwhile, the transistor M2 (amplification TFT) has a stray capacitor Ct itself. When the finger touches the screen, the coupling capacitor Cf may be generated between the fingerprint detection electrode d of a pixel and the concave-convex portions of the finger above the pixel. A gate potential of the M2 is varied with the coupling capacitor Cf (the gate potential of the M2 is determined based on proportions of the Cf, the Cs and the Ct, the larger the Cf is, the smaller the gate potential of the M2 may be, and vice versa), thereby a drain electrode current of the M2 is changed, so as to determine the concave-convex portions information of the finger.

To be specific, when the fingerprint above the fingerprint detection electrode d is concave, a capacitor formed between the concave fingerprint and the fingerprint detection electrode d is C1 (a capacitance value of C1 is smaller), a capacitance value of the C1 is small enough relative to that of Cs and Ct, so a charge receiving capacity of the C1 is limited. At this time, a reduced value of the gate potential of the M2 is small, and the gate potential of the M2 is not reduced enough to turn on the M2. Because the M2 is a P-type transistor, the M2 is turned off. The Y-Read Line acquires the initial current signal (the drain current flowing through the M2). At this time, the terminal may determine that a portion of the finger touching the finger detection electrode d is the concave fingerprint.

When the fingerprint above the fingerprint detection electrode d is convex, a capacitor formed between the convex fingerprint and the fingerprint detection electrode d is C2 (a capacitance value of C1 is large), a capacitance value of the C2 is large enough relative to that of Cs and Ct, so a charge receiving capacity of the C2 is strong. At this time, a reduced value of the gate potential of the M2 is large, and the M2 is turned on. Because the M2 is a P-type transistor, the M2 is turned off. The Y-Read Line acquires the amplified current signal. At this time, the terminal may determine that a portion of the finger touching the finger detection electrode d is the convex fingerprint.

To be specific, the reset sub-circuit includes a reset transistor, a gate electrode of the reset transistor is coupled to the first scanning line, a first electrode of the reset transistor is coupled to the fourth node, and a second electrode of the reset transistor is coupled to the reset signal output end. The conduction control sub-circuit includes a conduction control transistor, a gate electrode of the conduction control transistor is coupled to the second scanning line, a first electrode of the conduction control transistor is coupled to the fingerprint current signal reading line, and a second electrode of the conduction control transistor is coupled to the first electrode of the fingerprint information detection transistor.

To be specific, the data writing sub-circuit is configured to, in response to the first scanning signal from the first scanning line, determine whether to apply a data voltage on a data line to the first node and whether to apply an initial voltage output by the initial voltage output end to the third node; the light-emitting control sub-circuit is configured to, in response to a light-emitting control signal from the light-emitting control line, determine whether to connect the second node to the high-level output end.

To be specific, the compensation control sub-circuit includes: a first compensation control transistor, where a gate electrode of the first compensation control transistor is coupled to the second scanning line, a first electrode of the first compensation control transistor is coupled to the third node, and a second electrode of the first compensation control transistor is coupled to the first node; a second compensation control transistor, where a gate electrode of the second compensation control transistor is coupled to the first scanning line, a first electrode of the second compensation control transistor is coupled to the second electrode of the driving transistor, and a second electrode of the second compensation control transistor is coupled to the low-level output end.

To be specific, the display storage sub-circuit includes a storage capacitor, the data writing sub-circuit includes: a data voltage writing transistor, where a gate electrode of the data voltage writing transistor is coupled to the first scanning line, a first electrode of the data voltage writing transistor is coupled to the data line, and the second electrode of the data voltage writing transistor is coupled to the first node; and an initial voltage writing transistor, where a gate electrode of the initial voltage writing transistor is coupled to the first scanning line, a first electrode of the initial voltage writing transistor is coupled to the initial voltage output end, and the second electrode of the initial voltage writing transistor is coupled to the third node; the light-emitting control sub-circuit includes a light-emitting control transistor, where a gate electrode of the light-emitting control transistor is coupled to the light-emitting control line, a first electrode of the light-emitting control transistor is coupled to the high-level output end, and the second electrode of the light-emitting control transistor is coupled to the second node.

To be specific, the fingerprint information detection sub-circuit includes the reset sub-circuit, the reset sub-circuit includes a reset transistor, and the conduction control sub-circuit includes the conduction control transistor, and the driving transistor, the reset transistor, the conduction control transistor, the first compensation control transistor, the second compensation control transistor, the data voltage writing transistor, the initial voltage writing transistor and the light-emitting control transistor are P-type transistors; the first scanning signal from the first scanning line and the second scanning signal from the second scanning line have reverse phases.

All the transistors of the pixel driving circuit are P-type transistor, thereby simplifying the sub-circuit manufacturing process.

In an actual use, the first scanning line is identical to the second scanning line.

In the case that the first scanning line is identical to the second scanning line and the conduction control sub-circuit includes the conduction control transistor, the first compensation control transistor and the conduction control transistor are N-type transistors, and the initial voltage writing transistor, the data voltage writing transistor and the second compensation control transistor are P-type transistors; or the first compensation control transistor and the conduction control transistor are P-type transistors, and the initial voltage writing transistor, the data voltage writing transistor and the second compensation control transistor are N-type transistors.

Next, the pixel driving circuit in the present disclosure will be described in conjunction with embodiments.

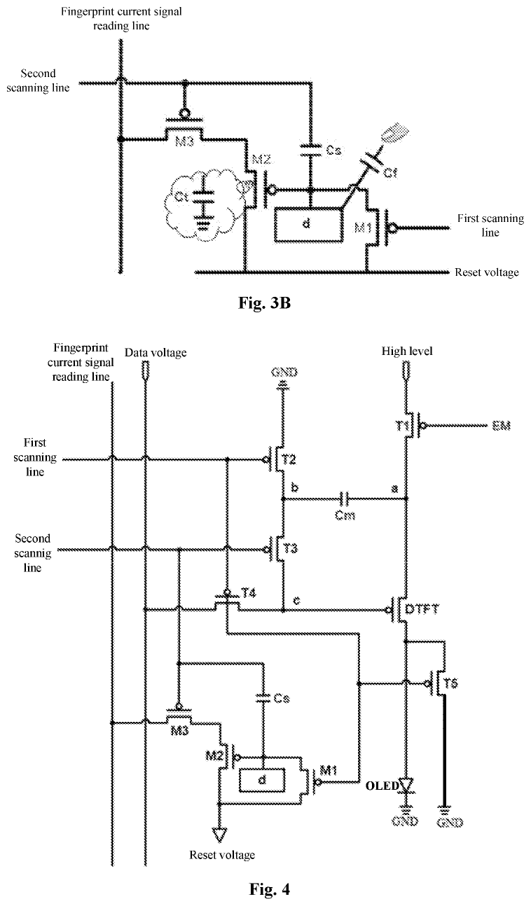

As shown in FIG. 4, the pixel driving circuit in some embodiment of the present disclosure includes a display driving unit and a fingerprint identification unit. The display driving unit includes a driving transistor DTFT, a display storage sub-circuit, a data writing sub-circuit, a light-emitting control sub-circuit and a compensation control sub-circuit. The fingerprint identification unit includes a fingerprint detection sub-circuit and a conduction control sub-circuit. The fingerprint detection sub-circuit includes a fingerprint detection electrode d and a fingerprint information detection sub-circuit. The fingerprint detection electrode is coupled to a fourth node. The fingerprint information detection sub-circuit includes: a reset transistor M1, where a gate electrode of the reset transistor M1 is coupled to the first scanning line Scan1, a source electrode of the reset transistor M1 is coupled to the fourth node, and a drain electrode of the reset transistor M1 is coupled to the reset signal output end configured to output a reset voltage Vcom; and a reference capacitor Cs, where a first end of the reference capacitor Cs is coupled to the second scanning line Scan2, and a second end of the reference capacitor Cs is coupled to the fourth node; and a fingerprint information detection transistor M2, where a gate electrode of the fingerprint information detection transistor M2 is coupled to the fourth node, a drain electrode of the fingerprint information detection transistor M2 is coupled to the reset signal output end configured to output a reset voltage Vcom.

The conduction control sub-circuit 122 includes a conduction control transistor M3, a gate electrode of the conduction control transistor M3 is coupled to the second scanning line Scan2, a source electrode of the conduction control transistor M3 is coupled to the fingerprint current signal reading line Y-Read Line, and a drain electrode of the conduction control transistor M3 is coupled to the source electrode of the fingerprint information detection transistor.

The compensation control sub-circuit includes: a first compensation control transistor T3, where a gate electrode of the first compensation control transistor T3 is coupled to the second scanning line Scan2, a source electrode of the first compensation control transistor T3 is coupled to the third node b, and a drain electrode of the first compensation control transistor T3 is coupled to the first node c; and a second compensation control transistor T5, where a gate electrode of the second compensation control transistor T5 is coupled to the first scanning line Scan1, a source electrode of the second compensation control transistor T5 is coupled to the source electrode of the driving transistor DTFT, and a drain electrode of the second compensation control transistor T5 is coupled to the GND.

The display storage sub-circuit includes a storage capacitor Cm, where a first end of the Cm is coupled to the third node, and a second end of the Cm is coupled to the second node a.

The data writing sub-circuit includes: a data voltage writing transistor T4, where a gate electrode of the data voltage writing transistor T4 is coupled to the first scanning line Scan1, a source electrode of the data voltage writing transistor T4 is coupled to the data line configured to output the data voltage Vdata, and a drain electrode of the data voltage writing transistor T4 is coupled to the first node c; and an initial voltage writing transistor T2, where a gate electrode of the initial voltage writing transistor T2 is coupled to the first scanning line Scan1, a source electrode of the initial voltage writing transistor T2 is coupled to the GND, and a drain electrode of the initial voltage writing transistor T2 is coupled to the third node b.

The light-emitting control sub-circuit includes a light-emitting control transistor T1, where a gate electrode of the light-emitting control transistor T1 is coupled to the light-emitting control line EM, a source electrode of the light-emitting control transistor T1 is coupled to the high-level output end configured to output the high level Vdd, and a drain electrode of the light-emitting control transistor T1 is coupled to the second node a. The gate electrode of the driving transistor DTFT is coupled to the first node c, the source electrode of the driving transistor DTFT is coupled to the second node a, and the drain electrode of the driving transistor DTFT is coupled to the anode of the OLED. The cathode of the OLED is coupled to the GND.

In some embodiments of the present disclosure, as shown in FIG. 4, in the fingerprint identification unit, M1 is a signal reset TFT, M2 is amplification TFT, and M3 is a switch TFT. The fingerprint identification unit further includes the fingerprint detection electrode d and a reference capacitor Cs.

In some embodiments of the present disclosure, as shown in FIG. 4, in the pixel driving unit, T1-T5 are switch TFTs, the DTFT is a driving TFT. The display driving unit further includes a storage capacitor Cm.

As shown in FIG. 4, the Scan1, Scan2 and the EM are input signal lines to turn on and turn off the switch TFTs in the two units. In addition, the Scan2 also serves as a fingerprint identification scanning line, and the Scan1 also serves as a reset line for the fingerprint identification.

The fingerprint is determined based on the signals feed back by pixel point fingerprint detection electrodes, an X-coordinate of a pixel point position touched by the finger is determined by the Scan2, and a Y-coordinate thereof is determined by the Y-Read Line.

In some embodiments of the present disclosure, as shown in FIG. 4, all the transistors are P-type transistors, thereby simplifying the sub-circuit manufacturing process. However, in an actual use, excepting the DTFT, the other transistors in FIG. 4 can be replaced by N-type transistors.

When the pixel driving circuit in FIG. 4 works, the display driving and the fingerprint identification are performed simultaneously.

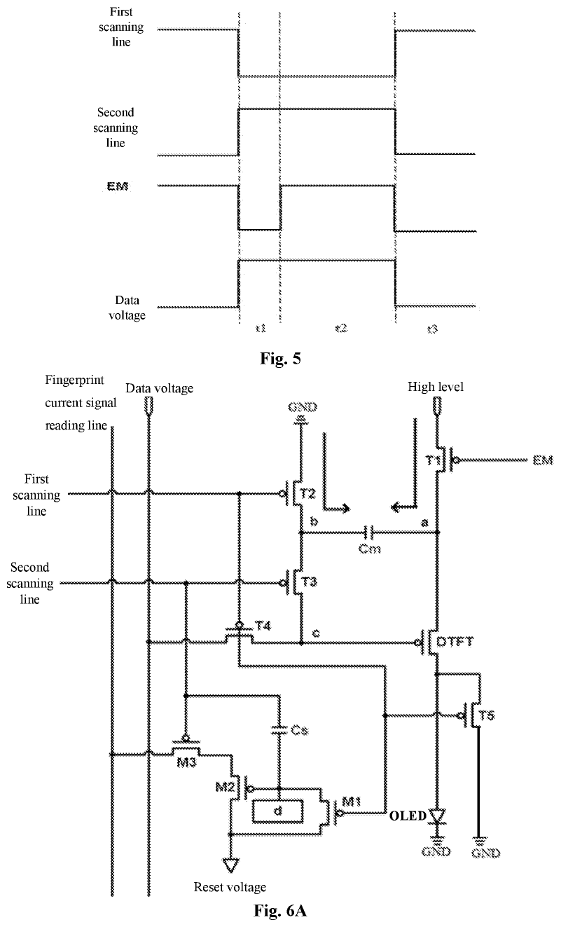

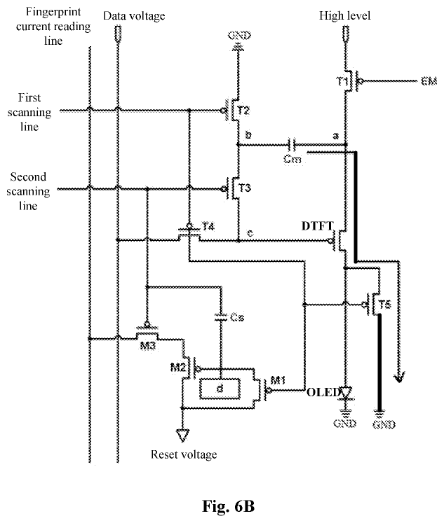

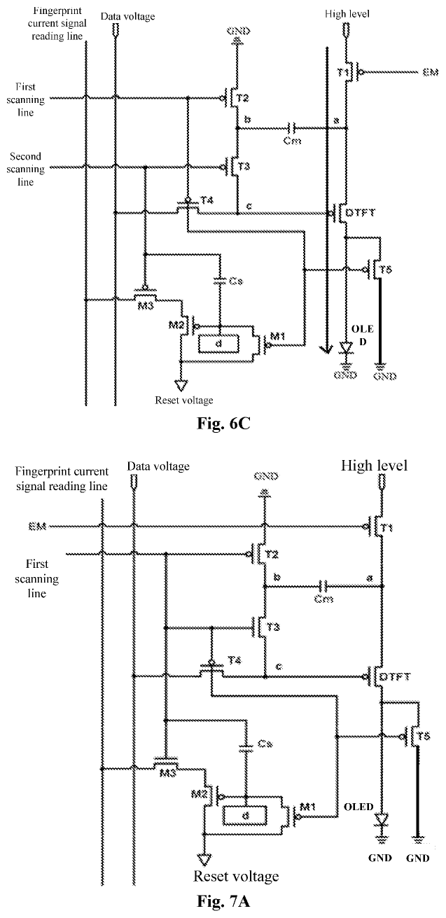

As shown in FIG. 5 and FIG. 6A, during the reset phase t1, the Scan1 outputs a low level, so as to turn on the M1, the Vcom provides an initial reset signal, a potential of the fingerprint detection electrode d is Vcom. At this time, the M2 cannot be turned on and it is turned off. At this time, the Scan2 outputs a high level, so the M3 is turned off.

The Scan1 and the EM both outputs low levels, the Scan2 outputs a high level, the T3 is turned off, the T1, T2, T4 and T5 are turned off, the third node b is coupled to the GND and a potential of the third node b is 0V, the second node a is coupled to the Vdd, the first node c is coupled to the Vdata on the data line Data, and a potential of the first node c is the Vdata.

As shown in FIG. 5 and FIG. 6B, during the compensation phase t2, since the Scan1 keeps outputting a low level and the Scan2 keeps outputting a high level, the states of the transistors of the fingerprint identification unit are not changed.

The Scan1 outputs a low level, and the EM and the Scan2 output high levels, T2, T4 and T5 are turned on, T1 and T3 are tuned off. At this time, the Cm discharges along a path in FIG. 6B until the potential of the second node a reaches a value of Vdata−Vthd, where the Vthd is the threshold voltage of the DTFT. During the discharging process, the current may not flow through the OLED, and the first node c is coupled to the Vdata.

As shown in FIG. 5 and FIG. 6C, during a light-emitting phase t3 (the light-emitting phase t3 is also a fingerprint identification signal acquisition phase), the Scan2 and the EM output low levels, the Scan1 outputs a high level, the M1 is turned off, the M3 is turned on. Besides the reference capacitor Cs, the fingerprint identification unit further includes a detection capacitor Cf formed by the finger and the fingerprint detection electrode d. Meanwhile, the transistor M2 (amplification TFT) has a stray capacitor Ct itself. When the finger touches the screen, the coupling capacitor Cf may be generated between the fingerprint detection electrode d of a pixel and the concave-convex portions of the finger above the pixel. A gate potential of the M2 is varied with the coupling capacitor Cf (the gate potential of the M2 is determined based on proportions of the Cf, the Cs and the Ct, the larger the Cf is, the smaller the gate potential of the M2 may be, and vice versa), thereby a drain electrode current of the M2 is changed, so as to determine the concave-convex portions information of the finger.

The working current of the M2 flows through the M3, and is transmitted to a signal receiving component of the terminal via the Y-Read Line.

During the light-emitting phase t3, the Scan1 outputs a high level, the Scan 2 and the EM output low levels, T2, T4 and T5 are turned off, T3 and T1 are turned on, the second end of the Cm (i.e., the second node a) is coupled to the Vdd, the first end of the Cm (i.e., the third node b) is floated. Because a voltage difference between two ends of the Cm cannot be changed suddenly, a potential of the first end of the Cm (i.e., the third node b) may be changed to a value of Vdd−Vdata+Vthd, where Vthd is the threshold voltage of the DTFT. Because the DTFT is a P-type transistor, the value of the Vthd is negative. At this time, the T3 is turned on, so a value of a potential of the gate electrode of the DTFT is changed to a value of Vdd−Vdata+Vthd.

According to a saturation current formula, a current I_{OLED} flowing through the OLED can be obtained through the following formula: I_{OLED}=K×(V_{GS}−Vₜₕ₁)²=K×[(Vdd−Vdata+Vth)−Vdd−Vth]²=K×Vdata², where V_{GS} is the gate-source voltage of the DTFT during the light-emitting phase t3.

It can be seen from the above formula, the current I_{OLED} flowing through the OLED is not affected by the Vthd, which is only related to the Vdata. As a result, it is able to solve the threshold voltage drifting due to the manufacturing process and the long-time operation of the driving transistor.

According to the present disclosure, the pixel compensation function and the fingerprint identification function are integrated, and the fingerprint identification function is embedded into the display screen, so the fingerprint identification function can be achieved when the finger touches the screen. As such, the manner in the related art where functions of the components are multiplied is changed, thereby improving the added value of products significantly.

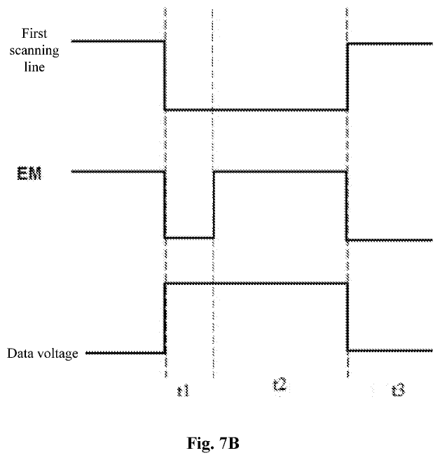

To be specific, as shown in FIG. 7A, in the context that the function of the driving pixel display unit is not changed, the types of the M3 and the T3 in FIG. 4 may be changed, i.e., the M3 and T3 may be N-type transistors. The gate electrodes of the M3 and the T3 are coupled to the first scanning line Scan1, the first end of the Cs is coupled to the Scan1, so it is able to reduce one scanning line (the second scanning line) while acquiring and controlling the fingerprint identification information. As shown in FIG. 7A, the Scan1 also serves as a fingerprint identification reset control line, a fingerprint identification scanning line and a display scanning line. FIG. 7B is a working time sequence diagram of the pixel driving circuit shown in FIG. 7A.

A method for driving the above pixel driving circuit is further provided in some embodiments of the present disclosure, where during each display period, the method includes: a reset step, including: during a reset phase and in response to a first scanning signal from the first scanning line, the data writing sub-circuit enabling a data voltage on the data line to be applied to the first node and the enabling an initial voltage output by the initial voltage output end to be applied to the third node; and in response to a light-emitting control signal from the light-emitting control line, the light-emitting control sub-circuit enabling the second node to be coupled to the high-level output end; a compensation step, including: in response to the light-emitting control signal, the light-emitting control sub-circuit enabling the second node to be disconnected with the high-level output end; in response to the first scanning signal, the compensation control sub-circuit enabling the second electrode of the driving transistor to be coupled to the low-level output end, to enable the display storage sub-circuit to discharge to the low-level output end through the driving transistor until a potential of the second node reaches a difference value the data voltage and a threshold voltage of the driving transistor and the driving transistor is turned off; a light-emitting step, including: during a light-emitting phase and in response to the first scanning signal, the data writing sub-circuit enabling the data line to be disconnected with the first node and enabling the initial voltage output end to be disconnected with the third node; in response to the light-emitting control signal, the light-emitting control sub-circuit enabling the second node to be coupled to the high-level output end; in response to a second scanning signal from the second scanning line, the compensation control sub-circuit enabling the first node to be coupled to the third node, to turn on the driving transistor to drive the light-emitting component to emit light, and enable a gate-source voltage of the driving transistor to compensate the threshold voltage of the driving transistor; the fingerprint detection sub-circuit converting touch fingerprint information to a fingerprint current signal; in response to the second scanning signal, the conduction control sub-circuit enabling the fingerprint detection sub-circuit to transmit the fingerprint current signal to the fingerprint current signal reading line.

To be specific, in the case that the fingerprint detection sub-circuit includes a fingerprint detection electrode and a fingerprint information detection sub-circuit, the fingerprint detection sub-circuit converting touch fingerprint information to a fingerprint current signal includes: converting, by the fingerprint detection electrode, the touch fingerprint information to a fingerprint capacitance; and converting, by the fingerprint information detection sub-circuit, the fingerprint capacitance to the fingerprint current signal.

A display substrate is further provided in some embodiments of the present disclosure, including the above pixel driving circuit.

Optionally, the display substrate further includes a silicon substrate, where the pixel driving circuit is arranged on the silicon substrate.

In some embodiments of the present disclosure, a base substrate of the display substrate is a monocrystalline substrate, and the active regions of the transistors in an array circuit layer of the pixel driving circuit are arranged within the monocrystalline substrate. Because a monocrystalline material has high carrier mobility, the transistors in the pixel driving circuit may have a good performance meanwhile a size of the transistor may be reduced. As such, the pixel driving circuit may not occupy a large area of the substrate.

In an actual use, the display substrate further includes n×N rows and m×M columns of pixel units, where the display substrate includes N rows and M columns of pixel driving circuit; the pixel driving circuit in an a^{th} row and b^{th} column is arranged in the pixel unit in a (n×a)^{th} row and (m×b)^{th} column; where n, N, m and M are positive integers, a is a positive integer smaller than or equal to N, b is a positive integer smaller than or equal to M.

In an actual use, the fingerprint identification units may not be arranged in each pixel unit. As such, the fingerprint identification units may be arranged based on a design parameter of the screen (the size or PPI) and according to a suitable pixel distribution period.

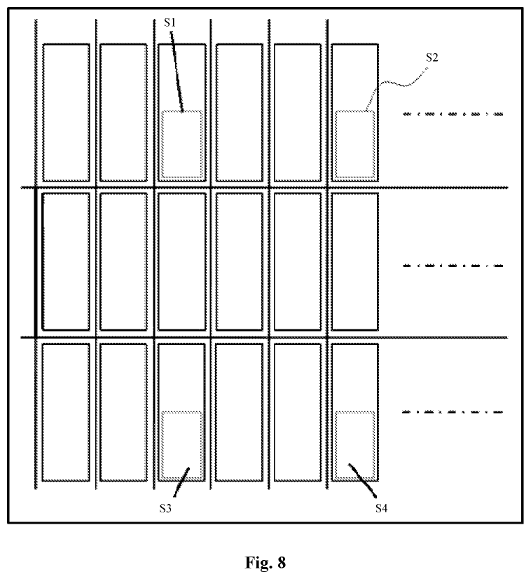

As shown in FIG. 8, a first pixel driving unit S1 with the fingerprint identification function is arranged in the first row and the third column, a second pixel driving unit S2 with the fingerprint identification function is arranged in the first row and the sixth column, a third pixel driving unit S3 with the fingerprint identification function is arranged in the third row and the third column, a fourth pixel driving unit S4 with the fingerprint identification function is arranged in the third row and the sixth column, the first pixel driving unit S1, the second pixel driving unit S2, the third pixel driving unit S3 and the fourth pixel driving unit S4 with the fingerprint identification function are the pixel driving units with the fingerprint identification function in some embodiments of the present disclosure. As shown in FIG. 8, the signal lines arranged lengthways are the date lines, and the signal lines arranged horizontally are the gate lines.

A display device is further provided in the present disclosure, including the above display substrate.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A pixel driving circuit, comprising a display driving unit and a fingerprint identification unit, wherein the display driving unit comprises:
a driving transistor, wherein a gate electrode of the driving transistor is coupled to a first node, a first electrode of the driving transistor is coupled to a second node, and a second electrode of the driving transistor is coupled to a light-emitting component;
a display storage sub-circuit, wherein a first end of the display storage sub-circuit is coupled to a third node, and a second end of the display storage sub-circuit is coupled to the second node;
a data writing sub-circuit, coupled to a first scanning line, the first node, the third node, a data line and an initial voltage output end;
a light-emitting control sub-circuit, coupled to a light-emitting line, a high-level output end and the second node; and
a compensation control sub-circuit, coupled to the first scanning line, a second scanning line, the first node, the third node, the second electrode of the driving transistor and a low-level output end, and configured to, during a compensation phase and in response to a first scanning signal from the first scanning line, enable the second electrode of the driving transistor to be coupled to the low-level output end, to enable the display storage sub-circuit to discharge to the low-level output end through the driving transistor until the driving transistor is turned off, and further configured to, during a light-emitting phase and in response to a second scanning signal from the second scanning line, enable the first node to be coupled to the third node, to turn on the driving transistor to drive the light-emitting component to emit light, and enable a gate-source voltage of the driving transistor to compensate a threshold voltage of the driving transistor;
the fingerprint identification unit comprises a fingerprint detection sub-circuit and a conduction control sub-circuit, wherein the fingerprint detection sub-circuit is configured to convert touch fingerprint information to a fingerprint current signal; and
the conduction control sub-circuit is coupled to the second scanning line, a fingerprint current signal reading line and the fingerprint detection sub-circuit, and configured to, during the light-emitting phase and in response to the second scanning signal, enable the fingerprint detection sub-circuit to be coupled to the fingerprint current signal reading line, to transmit the fingerprint current signal to the fingerprint current signal reading line.

2. The pixel driving circuit according to claim 1, wherein the fingerprint detection sub-circuit comprises a fingerprint detection electrode and a fingerprint information detection sub-circuit, the fingerprint detection electrode is configured to convert the touch fingerprint information to a fingerprint capacitance, and the fingerprint information detection sub-circuit is coupled to the fingerprint detection electrode and configured to convert the fingerprint capacitance to the fingerprint current signal.

3. The pixel driving circuit according to claim 2, wherein the fingerprint detection electrode is coupled to a fourth node;
the fingerprint information detection sub-circuit comprises:
a reset sub-circuit, coupled to the first scanning line, a reset signal output end and the fourth node, and configured to, in response to the first scanning signal, determine whether to connect the fourth node to the reset signal output end;
a reference capacitor, wherein a first end of the reference capacitor is coupled to the first scanning line or the second scanning line, and a second end of the reference capacitor is coupled to the fourth node; and
a fingerprint information detection transistor, wherein a gate electrode of the fingerprint information detection transistor is coupled to the fourth node, a first electrode of the fingerprint information detection transistor is coupled to the conduction control sub-circuit, and a second electrode of the fingerprint information detection transistor is coupled to the reset signal output end.

4. The pixel driving circuit according to claim 3, wherein the reset sub-circuit comprises a reset transistor, a gate electrode of the reset transistor is coupled to the first scanning line, a first electrode of the reset transistor is coupled to the fourth node, and a second electrode of the reset transistor is coupled to the reset signal output end;
the conduction control sub-circuit comprises a conduction control transistor, a gate electrode of the conduction control transistor is coupled to the second scanning line, a first electrode of the conduction control transistor is coupled to the fingerprint current signal reading line, and a second electrode of the conduction control transistor is coupled to the first electrode of the fingerprint information detection transistor.

5. The pixel driving circuit according to claim 1, wherein the data writing sub-circuit is configured to, in response to the first scanning signal from the first scanning line, determine whether to apply a data voltage on a data line to the first node and whether to apply an initial voltage output by the initial voltage output end to the third node;
the light-emitting control sub-circuit is configured to, in response to a light-emitting control signal from the light-emitting control line, determine whether to connect the second node to the high-level output end.

6. The pixel driving circuit according to claim 5, wherein the compensation control sub-circuit comprises:
a first compensation control transistor, wherein a gate electrode of the first compensation control transistor is coupled to the second scanning line, a first electrode of the first compensation control transistor is coupled to the third node, and a second electrode of the first compensation control transistor is coupled to the first node;
a second compensation control transistor, wherein a gate electrode of the second compensation control transistor is coupled to the first scanning line, a first electrode of the second compensation control transistor is coupled to the second electrode of the driving transistor, and a second electrode of the second compensation control transistor is coupled to the low-level output end.

7. The pixel driving circuit according to claim 6, wherein the display storage sub-circuit comprises a storage capacitor, the data writing sub-circuit comprises:
a data voltage writing transistor, wherein a gate electrode of the data voltage writing transistor is coupled to the first scanning line, a first electrode of the data voltage writing transistor is coupled to the data line, and the second electrode of the data voltage writing transistor is coupled to the first node; and
an initial voltage writing transistor, wherein a gate electrode of the initial voltage writing transistor is coupled to the first scanning line, a first electrode of the initial voltage writing transistor is coupled to the initial voltage output end, and the second electrode of the initial voltage writing transistor is coupled to the third node;
the light-emitting control sub-circuit comprises a light-emitting control transistor, wherein a gate electrode of the light-emitting control transistor is coupled to the light-emitting control line, a first electrode of the light-emitting control transistor is coupled to the high-level output end, and the second electrode of the light-emitting control transistor is coupled to the second node.

8. The pixel driving circuit according to claim 7, wherein the fingerprint information detection sub-circuit comprises the reset sub-circuit, the reset sub-circuit comprises a reset transistor, and the conduction control sub-circuit comprises the conduction control transistor, and the driving transistor, the reset transistor, the conduction control transistor, the first compensation control transistor, the second compensation control transistor, the data voltage writing transistor, the initial voltage writing transistor and the light-emitting control transistor are P-type transistors;
the first scanning signal from the first scanning line and the second scanning signal from the second scanning line have reverse phases.

9. The pixel driving circuit according to claim 7, wherein the first scanning line is identical to the second scanning line.

10. The pixel driving circuit according to claim 9, wherein the conduction control sub-circuit comprises the conduction control transistor, the first compensation control transistor and the conduction control transistor are N-type transistors, and the initial voltage writing transistor, the data voltage writing transistor and the second compensation control transistor are P-type transistors.

11. The pixel driving circuit according to claim 9, wherein the conduction control sub-circuit comprises the conduction control transistor, the first compensation control transistor and the conduction control transistor are P-type transistors, and the initial voltage writing transistor, the data voltage writing transistor and the second compensation control transistor are N-type transistors.

12. A method for driving the pixel driving circuit according to claim 1, wherein during each display period, the method comprises:
a reset step, comprising: during a reset phase and in response to a first scanning signal from the first scanning line, the data writing sub-circuit enabling a data voltage on the data line to be applied to the first node and the enabling an initial voltage output by the initial voltage output end to be applied to the third node; and in response to a light-emitting control signal from the light-emitting control line, the light-emitting control sub-circuit enabling the second node to be coupled to the high-level output end;
a compensation step, comprising: in response to the light-emitting control signal, the light-emitting control sub-circuit enabling the second node to be disconnected with the high-level output end; in response to the first scanning signal, the compensation control sub-circuit enabling the second electrode of the driving transistor to be coupled to the low-level output end, to enable the display storage sub-circuit to discharge to the low-level output end through the driving transistor until a potential of the second node reaches a difference value the data voltage and a threshold voltage of the driving transistor and the driving transistor is turned off;
a light-emitting step, comprising: during a light-emitting phase and in response to the first scanning signal, the data writing sub-circuit enabling the data line to be disconnected with the first node and enabling the initial voltage output end to be disconnected with the third node; in response to the light-emitting control signal, the light-emitting control sub-circuit enabling the second node to be coupled to the high-level output end; in response to a second scanning signal from the second scanning line, the compensation control sub-circuit enabling the first node to be coupled to the third node, to turn on the driving transistor to drive the light-emitting component to emit light, and enable a gate-source voltage of the driving transistor to compensate the threshold voltage of the driving transistor; the fingerprint detection sub-circuit converting touch fingerprint information to a fingerprint current signal; in response to the second scanning signal, the conduction control sub-circuit enabling the fingerprint detection sub-circuit to transmit the fingerprint current signal to the fingerprint current signal reading line.

13. The method according to claim 12, wherein in the case that the fingerprint detection sub-circuit comprises a fingerprint detection electrode and a fingerprint information detection sub-circuit, the fingerprint detection sub-circuit converting touch fingerprint information to a fingerprint current signal comprises:
converting, by the fingerprint detection electrode, the touch fingerprint information to a fingerprint capacitance; and
converting, by the fingerprint information detection sub-circuit, the fingerprint capacitance to the fingerprint current signal.

14. A display substrate comprising the pixel driving circuit according to claim 1.

15. The display substrate according to claim 14, further comprising a silicon substrate, wherein the pixel driving circuit is arranged on the silicon substrate.

16. The display substrate according to claim 14, further comprising n×N rows and m×M columns of pixel units, wherein the display substrate comprises N rows and M columns of pixel driving circuit;
the pixel driving circuit in an a^{th} row and b^{th} column is arranged in the pixel unit in a (n×a)^{th} row and (m×b)^{th} column;
wherein n, N, m and M are positive integers, a is a positive integer smaller than or equal to N, b is a positive integer smaller than or equal to M.

17. A display device comprising the display substrate according to claim 14.
